(19) United States
(12) Patent Application Publication
(10) Pub. No.: US 2023/0120992 A1
(43) Pub. Date: Apr. 20, 2023

(54) WI-FI BASED FIXED WIRELESS ACCESS PROTOCOL

(71) Applicant: SEMICONDUCTOR COMPONENTS INDUSTRIES, LLC, Phoenix, AZ (US)

(72) Inventors: Ali ROUHI, Oakland, CA (US); Sigurd SCHELSTRAETE, Menlo Park, CA (US); Hossein DEHGHAN-FARD, Diablo, CA (US); Qasem Saif ALDRUBI, Fremont, CA (US); Wanjui HO, Fremont, CA (US); Laurent Alexandre PIERRUGUES, San Jose, CA (US); Iyad A. ALFALUJAH, Bedminster, NJ (US)

(73) Assignee: SEMICONDUCTOR COMPONENTS INDUSTRIES, LLC, Phoenix, AZ (US)

(21) Appl. No.: 17/995,253

(22) PCT Filed: Mar. 25, 2022
(86) PCT No.: PCT/CN2022/083044

§ 371 Date: Sep. 30, 2022

Related U.S. Application Data
(60) Provisional application No. 63/166,814, filed on Mar. 26, 2021.

(51) Int. Cl. H04W 48/10; H04W 74/08

(52) U.S. Cl. CPC H04W 48/10; H04W 74/08

(57) ABSTRACT

A method may include determining, by an access point, which stations among multiple stations are permitted access to a wireless communication medium in a subsequent uplink frame. The method may also include broadcasting an uplink map to the stations, where the uplink map identifies a first station of the multiple stations as permitted access to the wireless communication medium. The uplink map may also identify an allocation of the subsequent uplink frame for the first station. The method may also include, during the allocation of the subsequent uplink frame allocated to the first station, receiving: an acknowledgment (ACK) of downlink data transmitted to the first station, uplink data, a resource allocation request from the first station requesting access to a second subsequent uplink frame, and/or combinations thereof.

### FIELD

The implementations discussed herein are related to a fixed wireless access protocol.

### BACKGROUND

Unless otherwise indicated herein, the materials described herein are not prior art to the claims in the present application and are not admitted to be prior art by inclusion in this section.

Home, office, stadium, and outdoor networks, a.k.a. wireless local area networks (WLAN) are established using a device called a Wireless Access Point (WAP). The WAP may include a router. The WAP wirelessly couples all the devices of the local network, e.g. wireless stations such as: computers, printers, televisions, digital video (DVD) players, security cameras and smoke detectors to one another and to the Cable or Subscriber Line through which Internet, video, and television is delivered to the local network. Most WAPs implement the IEEE 802.11 standard which is a contention-based standard for handling communications among multiple competing devices for a shared wireless communication medium on a selected one of a plurality of communication channels. The frequency range of each communication channel is specified in the corresponding one of the IEEE 802.11 protocols being implemented, e.g. “a”, “b”, “g”, “n”, “ac”, “ad”, “ax”, “ay”, “be”. Communications follow a hub and spoke model with a WAP at the hub and the spokes corresponding to the wireless links to each ‘client’ device or station (STA) utilizing the WLAN.

The subject matter claimed herein is not limited to implementations that solve any disadvantages or that operate only in environments such as those described above. Rather, this background is only provided to illustrate one example technology area where some implementations described herein may be practiced.

### SUMMARY

This Summary is provided to introduce a selection of concepts in a simplified form that are further described below in the Detailed Description. This Summary is not intended to identify key features or essential characteristics of the claimed subject matter, nor is it intended to be used as an aid in determining the scope of the claimed subject matter.

Some example implementations described herein generally relate to the use of a new frame of reference for wireless communications that includes a fixed wireless access (FWA) technology. Under FWA, an uplink frame and downlink frame (together forming a super frame) are utilized to determine directionality of traffic for given periods of time.

One or more implementations may include an example method or system that includes determining, by an access point, which stations among multiple stations are permitted access to a wireless communication medium in a subsequent uplink frame. The method or system may also include broadcasting an uplink map to the stations, where the uplink map identifies a first station of the multiple stations as permitted access to the wireless communication medium. The uplink map may also identify an allocation of the subsequent uplink frame for the first station.

One or more implementations may include an example method or system that includes receiving, by a station and from an access point, an uplink map identifying an allocation within a subsequent uplink frame within which the station has access to a wireless medium, the uplink map including a start time and an end time for the allocation. The method may also include, based on the start time of the allocation matching a current time, transmitting information to the access point such that the transmission of information is completed before the end time.

The present disclosure may be implemented in hardware, firmware, or software. Associated devices and circuits are also claimed. Additional features and advantages of the present disclosure will be set forth in the description which follows, and in part will be obvious from the present disclosure, or may be learned by the practice of the present disclosure. The features and advantages of the present disclosure may be realized and obtained by means of the instruments and combinations particularly pointed out in the appended claims. These and other features of the present disclosure will become more fully apparent from the following description and appended claims or may be learned by the practice of the present disclosure as set forth hereinafter.

### BRIEF DESCRIPTION OF THE DRAWINGS

Example implementations will be described and explained with additional specificity and detail through the use of the accompanying drawings in which:

FIG. 1 illustrates an example of a super frame used in fixed wireless access (FWA) technology, described according to at least one implementation of the present disclosure.

FIG. 2 illustrates an example system for communicating using FWA, described according to at least one implementation of the present disclosure.

FIG. 3 illustrates an example diagram 300 of a series of communications using FWA, described according to at least one implementation of the present disclosure.

FIG. 4 illustrates an example uplink (UL) map frame, described according to at least one implementation of the present disclosure.

FIG. 5 illustrates an example resource allocation request frame, described according to at least one implementation of the present disclosure.

FIG. 6 illustrate an example visualization of potential collisions in a contention slot of an uplink frame, described according to at least one implementation of the present disclosure.

FIG. 7 illustrates a flowchart of an example method of communication using FWA, described according to at least one implementation of the present disclosure.

FIG. 8 illustrates a flowchart of an example method of coordinating FWA super frames across multiple access points, described according to at least one implementation of the present disclosure.

FIG. 9 illustrates a flowchart of an example method of coordinating timing information to facilitate communication using FWA, described according to at least one implementation of the present disclosure.

FIG. 10 illustrates a flowchart of an example method of accounting for latency to facilitate communication using FWA, described according to at least one implementation of the present disclosure.

FIG. 11 illustrates a flowchart of an example method of prioritizing or scheduling data for communication using FWA, described according to at least one implementation of the present disclosure.

FIG. 12 illustrates a flowchart of an example method of communicating ACKs to an access point using orthogonal frequency-division multiple access (OFDMA), described according to at least one implementation of the present disclosure.

FIG. 13 illustrates a flowchart of an example method of accounting for latency to facilitate communication using FWA, described according to at least one implementation of the present disclosure.

FIG. 14 illustrates a diagrammatic representation of a machine in the example form of a computing device, described according to at least one implementation of the present disclosure.

### DETAILED DESCRIPTION OF SOME EXAMPLE IMPLEMENTATIONS

Example aspects described herein include improvements to Wi-Fi channel access protocols and frame sequences to enable Wi-Fi to be used as a Fixed Wireless Access (FWA) technology. In using FWA, an access point (AP) may designate a super frame with a designated downlink frame and a designated uplink frame, which together form the super frame. During the downlink frame and the uplink frame, communications generally or exclusively flow in one direction, for example, from the AP to stations (STAs) during the downlink frame and from the STAs to the AP during the uplink frame.

One challenge to using Wi-Fi in the mmWave bands (e.g., between 24.25 GHz and 29.5 GHz) is that uplink and downlink transmissions may be sent in separate, alternating time slots (for example, to comply with regulations, standards, requirements, governmental restrictions, among other reasons). One example reason for this includes aligning Wi-Fi signals with time-slotted LTE/5G systems operating in the same band. For example, those technologies may utilize specific time slots for uplink communications and a separate and distinct time for downlink communications. Often cellular base stations (BS) may be located on a tower with three BSs, each pointing in a different direction and covering 120° so that together, the three BSs cover a full 360°. However, because of the proximity of the BS to each other, when one of the BSs is broadcasting the other BSs are unable to accurately detect signals being transmitted to the BS. For this reason, the BS on a tower may coordinate among themselves (and/or among other BSs) such that all of the BSs are receiving signals at the same time and transmitting signals at the same time. Additionally, the use of the Wi-Fi clear channel assessment (CCA) mechanism (e.g., the listening for radio frequency (RF) transmissions at the physical layer) may be ineffective as STAs may be unable to hear each other's signals when contending for the medium because of the high directionality of the transmissions. Such high directionality creates many more hidden nodes than in a typical Wi-Fi deployment.

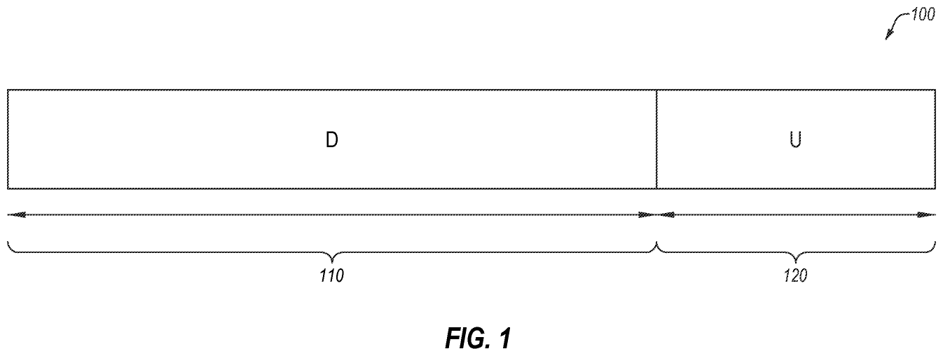

FIG. 1 illustrates an example of a super frame 100 used in fixed wireless access (FWA) technology, described according to at least one implementation of the present disclosure. The super frame 100 may include a downlink frame 110 and an uplink frame 120.

The FWA technology may represent an architecture and protocol in which transmissions are generally transmitted in one direction. For example, an AP may broadcast some information generally, and may transmit data to specific STAs in the downlink frame 110. The AP may not be expecting or even listening for transmissions directed to the AP during the downlink frame 110. Similarly, during the uplink frame 120, the AP may be listening for transmissions (including those from specific STAs at certain times) and may not transmit any data during the uplink frame 120. For example, rather than being sent immediately, all acknowledgments (such as ACKs to quality of service (QoS) frames) may be delayed and sent in a subsequent transmit frame. For example, ACKs to received downlink data are delayed and sent in a subsequent uplink slot, and ACKs to received uplink data are delayed and sent in a subsequent downlink slot. For all transmissions in a system using FWA (whether uplink or downlink), the transmissions may operate with a delayed ACK configuration.

To facilitate the architecture the AP may designate given slots within the uplink frame 120 for given STAs. When a STA is assigned an uplink slot in the uplink frame 120, the STA may use this slot to send ACKs, data, management frames, or resource allocation requests, or a mix of these. ACKs and other high-priority information may be prioritized and sent first to minimize nor reduce latency and buffering. In some implementations, STAs may request access to the uplink frame 120 via a resource allocation request to the AP. The resource allocation request may indicate to the AP that the STA has data to transmit to the AP and an amount of data/amount of air time requested. Such requests may be sent during a contention period or during an allocation specifically for the STA. An example of a resource allocation request is described with greater detail in reference to FIG. 5.

In some implementations, FWA may utilize multi-user multi-input multi-output (MU-MIMO) for downlink (and uplink) data transmissions and may utilize UL orthogonal frequency-division multiple access (OFDMA) for reducing the overhead of the UL ACKs.

In a first example implementation, the duration of the UL frame 120 and the DL frame 110 may be variable as a function of the envisioned uplink and downlink throughput, the number of deployed STAs, and/or the usage scenarios. For example, an AP that is managing or coordinating the super frame 100 may be programmed with a specific duration of the downlink frame 110 and the uplink frame 120. In some implementations, the DL frame 110 may be longer than the UL frame 120, such as between about 1.5 times as long and 5 times as long. In some implementations, the DL frame 110 may be about twice as long as the UL frame 120. In some implementations, the DL frame 110 may be 13 msec and the UL frame 120 may be 7 msec (which may be beneficial for maximizing throughput but may increase latency). As another example, the DL frame 110 may be 7 msec and the UL frame 120 may be 3 msec (which may be a balance between throughput and latency). As a further example, the DL frame 110 may be 464 μsec and the UL frame 120 may be 143 μsec (which may be consistent with 5G networks). In these and other embodiments, when a size and/or ratio of the DL frame 110 and the UL frame 120 in the super frame 100 is selected, the size and/or ratio that is selected may be consistently used throughout network operations.

In some example implementations, the duration of the downlink frame 110 and the uplink frame 120 may be selected to be consistent with the UL and DL slots used by 5G systems in the same band. In these and other implementations, there may be some flexibility in the sense that FWA UL transmissions may be permitted in the 5G downlink slot. This can be done permitted, or a fixed UL/DL ratio may be chosen. In these and other implementations, a priori UL/DL allocations may be selected and utilized based on, for example, synchronization with 5G new radio (NR) transmission slots (assuming 120 KHz subcarrier spacing, 0.125 ms time slots). In these and other implementations, the 5G implementation may include a gap between the DL frame 110 and the UL frame 120. For example, the DL frame 110 may be 464 μsec, followed by an 18 μsec gap, and the UL frame 120 may be 143 μsec, yielding a super frame 100 that is 625 μsec in total. If part of the DL frame 110 is used for uplink transmissions, a final UL/DL ratio may be different or slightly modified as compared to, for example, the 5G NR transmission slots.

To utilize FWA, both AP and STAs are to operate with a common understanding of the time slots and the time intervals within them. There are a number of ways to establish such a common understanding of the clock. For example, both the AP and the STAs may have access to a shared external clock (e.g. pulse-per-second (PPS) clock distributed by GPS). The start times of the super frames 100 may be defined in terms of the shared external clock. In these and other implementations, both the AP and the STAs may include some interface to the shared external clock. For example, a given tower may include three cellular BS s (acting as the AP), each covering 120°. The three BSs may be synchronized with each other via PPS signals. Various wireless network devices (such as routers, etc.) may be in communication with the three BSs as the STAs. The STAs may coordinate their timing with the BSs and/or with the PPS signals.

As another example, there may be no shared external clock between the AP and the STAs. In such an implementation, the AP may operate as the master of the clock. The STAs may operate with free-running clocks that may be periodically adjusted to follow the master clock from the AP. One possible implementation is to use the time synchronization function (TSF) mechanism defined in 802.11. For example, under 802.11, each STA maintains a local 64-bit TSF timer. The AP may broadcast (e.g., in a beacon) the value of its TSF timer at the time the communication is broadcasted. STAs may compare the received TSF in the broadcast with their local TSF and may adjust their timing accordingly (e.g., if the clock of the STA is off by 5 μsec, the STA may offset its timing by 5 μsec. Additionally or alternatively, the STA may update its own local TSF to match that of the AP. In these and other embodiments, a combination of the AP synchronizing with an external clock (e.g., via the PPS signal) and the STAs synchronizing with the AP (e.g., via the TSF signals in beacons) may be utilized.

In some implementations (such as those consistent with 802.11) devices such as APs and STAs may include a TSF timer with modulus 2⁶⁴ counting in increments of microseconds. In such an implementation, a STA sending a beacon frame may set the value of the beacon frame's timestamp so that it equals the value of the STA's TSF timer at the time that the data symbol containing the first bit of the timestamp is transmitted to the physical layer (PHY) plus the transmitting STA's delays through its local physical layer (PHY) from the media access control (MAC)-PHY interface to its interface with the wireless medium. Upon receiving a beacon, a STA may update its TSF timer according to the following algorithm: the received timestamp value may be adjusted by adding an amount equal to the receiving STA's delay through its local PHY components plus the time since the first bit of the timestamp was received at the MAC-PHY interface. In the case of an infrastructure basic service set (BSS), the STA's TSF timer may then be set to the adjusted value of the timestamp. Stated another way, in such implementations the STA may align its TSF counter with the AP's TSF counter every time it receives a time stamp value (e.g. in the beacon).

In some implementations, a STA's TSF timer may be accurate to within ±100 parts per million (ppm). Assuming a beacon period of e.g. 100 msec and a maximal relative timing offset of 200 ppm between AP and STA, the maximum clock slip between two beacons would be: (100×10⁻³)×(200×10⁻³)=200 μsec. In these and other implementations, for determining boundaries of the super frame 100, including the downlink frame 110, the uplink frame 120, and transmit opportunities within the super frame 100, this accuracy is sufficient. If higher accuracy is needed or desired, the periodicity with which timing information is transmitted between the AP and the STAs (e.g., the beacon), may be increased.

In some implementations, such as those associated with super frames 100 used in conjunction with 5G systems, the super frame 100 boundaries may be aligned with the boundaries of other transmitting devices, other APs, base stations (BSs), among other such devices, such as by aligning with pre-established 5G super frames. In these and other implementations, the AP may utilize some interface towards an external synchronization reference to verify the TSF clock is aligned with these boundaries. For example, the AP may periodically compare it's free-running TSF clock with the external clock.

In some implementations, there may be no channel contention of carrier sense multiple access (CSMA) back-off between successive frames in the downlink (or uplink if a STA sends multiple frames in its allocated slot). Instead, the AP and STA may utilize a minimum time between successive transmitted packets. This time may be configurable and may be denoted as FWA_IFS.

The final value of FWA_IFS may be determined based on the capabilities of the AP and the STAs, such as how long it takes for a device to be able to receive a new frame after completion of the previous frame.

Table 1 summarizes some example parameters involved in the configuration of the FWA protocol.

TABLE 1
FWA parameters

| Parameter | Meaning |
|---|---|
| DL_FRAME | Duration of the downlink frame in each super frame |
| UL_FRAME | Duration of the uplink frame in each super frame |
| SLOT_PERIOD | Duration of the entire super frame - equal to DL_FRAME + |
| | UL_FRAME |
| UL_MAP_PERIOD | The periodicity with which the UL MAP frame is sent by the |
| | AP (or in some implementations, the periodicity with which |
| | the frame is added to the management buffer) |
| ACK_PERIOD | Pending ACK requests may be updated with a period of |
| | ACK_PERIOD. |
| ACK_OFFSET | The timing of the updates of the pending ACK requests offset |
| | relative to the UL_MAP_PERIOD |
| BEACON_PERIOD | The periodicity with which the Beacon frame is sent by the |
| | AP (or in some implementations, the periodicity with which |
| | the frame is added to the management buffer) |
| FWA_IFS | The minimum interframe spacing between successive |
| | transmissions |

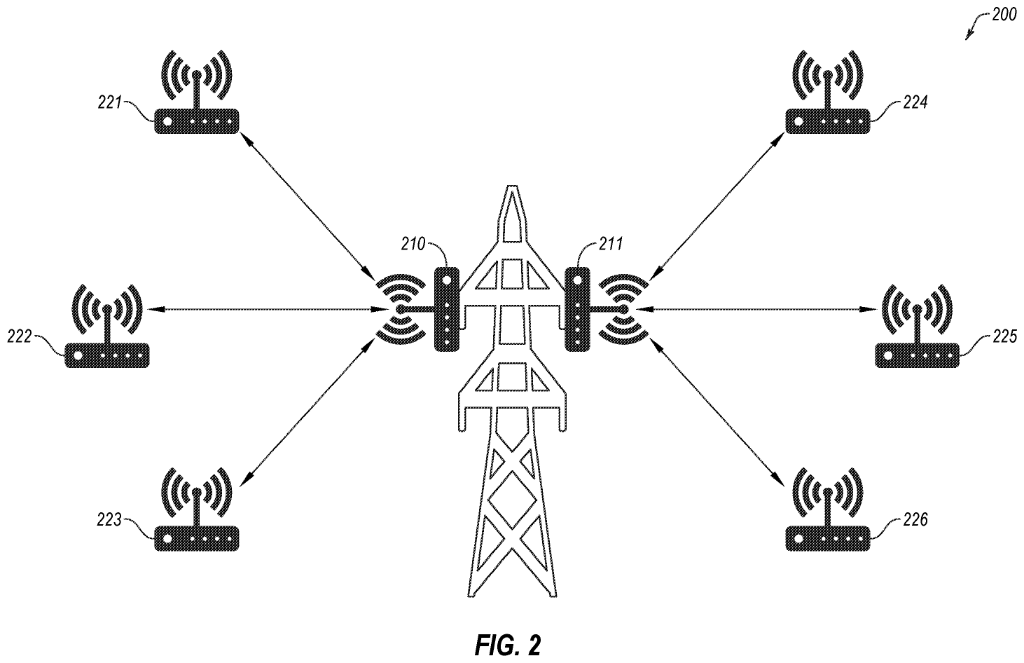

FIG. 2 illustrates an example system 200 for communicating using FWA, described according to at least one implementation of the present disclosure. The system 200 may include one or more access points (APs) 210 and 211 that may manage or control the use of the FWA. In these and other embodiments, multiple stations (STAs) (such as a first STA 221 and/or second STA 222, third STA 223, fourth STA 224, fifth STA 225, and/or sixth STA 226) may communicate wirelessly with the APs 210 and 211. While reference may be made to AP 210, it will be appreciated that AP 211 operates in the same or a similar manner.

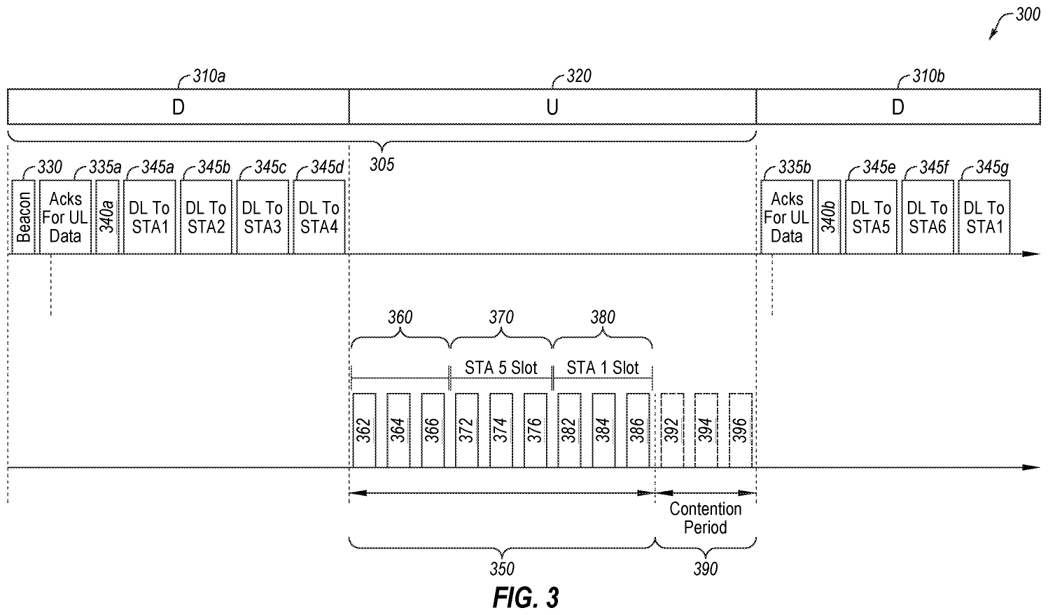

The AP 210 may control when downlink and uplink data is sent (e.g., the timing and division of the super frame) and determines which stations of the STAs 221-226 can transmit in a given uplink frame. The AP 210 and the STAs 221-226 may communicate with each other using FWA. An example of the various communications is illustrated in FIG. 3.

For each super frame, the AP 210 may send an allocation that specifies the STAs that are allowed to transmit in a subsequent uplink frame and the times at which they are granted access to the medium.

While illustrated as various access points, or routers, it will be appreciated that any type or style of electronic device that communicates wirelessly with the AP 210 is contemplated. An example AP 210 can be a multiple-input multiple-output (MIMO) apparatus supporting as many as N×N discrete communication streams over N antennas. In an example the AP 210 as a MIMO apparatus signal processing units can be implemented as N×N. In various implementations, the value of N can be 4, 6, 8, 12, 16, etc. Extended MIMO operation enables the use of up to 2N antennae in communication with another similarly equipped wireless system.

FIG. 3 illustrates an example diagram 300 of a series of communications using FWA, described according to at least one implementation of the present disclosure. The FIG. 3 may be described using the system 200 as an example of the various physical devices performing the communications illustrated in FIG. 3. The diagram 300 illustrates a super frame 305 including a first downlink frame 310a and an uplink frame 320, and the first part of the next super frame with its associated second downlink frame 310b.

The first downlink frame 310a may include a beacon 330a, one or more ACKs 335a for uplink data received during the previous uplink frame, an uplink map 340a, and one or more downlink slots 345 so various stations, such as a first downlink slot 345a transmitting data to a first station (such as the first station 221 of FIG. 2), a second downlink slot 345b transmitting data to a second station (such as the second station 222 of FIG. 2), a third downlink slot 345c transmitting data to a third station (such as the third station 223 of FIG. 2), and a fourth downlink slot 345d transmitting data to a fourth station (such as the fourth station 224 of FIG. 2).

The beacon 330a may include one or more pieces of information describing aspects of a wireless network, and may be characterized as a management frame. In some implementations, the beacon 330a may include some or all of the information that beacons may include as described in 802.11. For example, the beacon 330a may include timestamp information (e.g., the TSF information of the AP 210), a beacon interval (e.g., the periodicity with which the AP 210 may transmit the beacon 330a), capability information regarding the network and/or the AP 210, a service set identifier (SSID) of the network, and/or other information. In traditional Wi-Fi, a beacon may contain information that may not be relevant for the FWA (e.g. enhanced distributed channel access (EDCA) information, delivery traffic indication information (DTIM), supported rates, HT capabilities, HT information, wireless multimedia extensions (WME), Wi-Fi Multimedia (WMM), extended capabilities, among others). To increase efficiency, the beacon 330a in example implementations may include content limited as compared to a traditional Wi-Fi beacon.

The ACKs 335a during the downlink frame 310a may include any acknowledgments by the AP 210 of previously received data received in a previous uplink frame. Acknowledgments can be similar to the ACK format used in Wi-Fi, such as block ACK and multi-STA block ACK. The multi-STA block ACK may be used in the downlink to acknowledge some or all correctly received uplink subframes during the previous uplink frame in the previous super frame. In these and other implementations, the transmission of the ACKs 335a may be delayed as compared to traditional Wi-Fi.

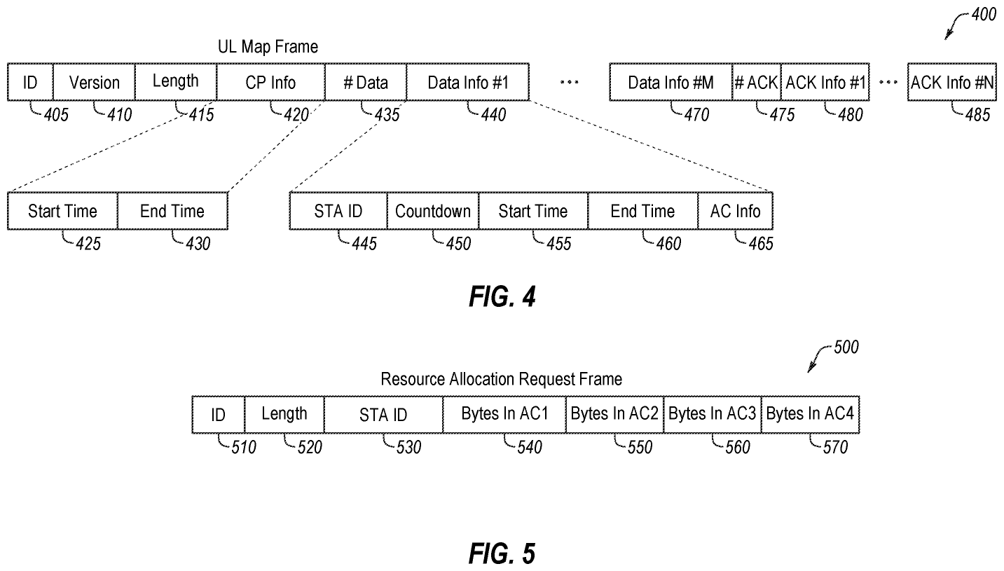

The uplink map 340a may include information regarding various aspects of one or more upcoming uplink frames, such as the uplink frame 320, or the uplink frame 320 as well as one or more future uplink frames (not illustrated). Such information may identify the start time, which STAs will be permitted to send data during the UL frame 320 (e.g., a list of all STAs which receive an allocation of the wireless medium during the UL frame 320), what type of data will be permitted, when the various allocations of the STAs start and/or end, when a contention period may be open for unscheduled transmissions, among other information. In some implementations, the uplink map 340a may follow a consistent structure or format across devices utilizing FWA, an example of which is illustrated in FIG. 4. In some implementations, the uplink map 340a may be treated, encapsulated, and/or otherwise handled as a management frame or packet.

In some implementations, the uplink map 340a may be sent as a broadcast so that it may be received by all STAs. For example, the AP 210 may broadcast the uplink map 340a such that all of the STAs 221-226 are able to receive the uplink map 340a.

As illustrated in FIG. 3, the uplink map 340a is shown as being transmitted towards the start of the downlink frame 310a. In some implementations, the uplink map 340a may include, among other things, the ACK info for the subsequent uplink slot (e.g., identifying slots 362, 364, and 366 within an administrative portion 360 of the uplink frame 320). Example implementations include the acknowledgments for the downlink data transmissions (e.g., the DL data transmissions in the slots 345a, 345b, 345c, and 345d) in the current downlink frame (310a) to be sent in the uplink frame 320 that immediately follows it. If the uplink map 340a is sent at the beginning of the downlink frame 310a, this implies that at the start of the downlink frame 310a, the AP is to be aware of which traffic will be scheduled for the entire slot.

In some implementations, to improve accurate information on which downlink transmissions were sent and to which STAs, the uplink map 340a may be delayed until later in the downlink frame 310a, such as after one or more of the DL data transmissions 345a-345d. By doing so, the information regarding which DL data transmissions 345a-345d were sent does not need to be available before or at the start of the downlink frame 310a. In these and other implementations, a balance may be achieved between delaying sending the uplink map 340a until later in the downlink frame 310a to have more accurate information and the STAs having sufficient time to receive and parse the content of the uplink map 340a. For example, the AP 210 may delay broadcasting the uplink map 340a until after a threshold number of DL data transmissions, until after the downlink frame 310a has been completely allocated for transmissions, among other points in time. Additionally, there may be other limiting constraints to the delay, such as not delaying beyond a threshold amount of time until the end of the downlink frame 310a (such as 100 μsec), or a threshold number of DL data transmissions remaining, among others. Example implementations include sending the uplink map 340a later in the downlink frame 310a, with enough time until the end of the downlink frame 310a to make sure that all STAs can comfortably decode the uplink map 340a and prepare for the allocated transmission times in the uplink frame 320.

In example implementations in which the uplink map 340a may be broadcast towards the beginning of the downlink frame 310a, an estimation or projection by the AP 210 may be included of which downlink data transmissions 345a-345d would be sent, and therefore which STAs are expecting an ACK slot in the following uplink frame 320. Even if the AP 210 is incorrect on the estimation, may not lead to major issues. For example, assigning an ACK slot (e.g., the administrative slot 366) to a STA that does not have any data to acknowledge may result in a slight reduction in efficiency. As another example, not including an ACK slot for a STA that did receive data via one of the DL data transmissions 345a-345d may result in the signaling of the ACK being done in the next uplink frame (not illustrated). This may result in some additional delay but may also not create functional issues.

The DL data transmissions 345a-345d may represent transmissions of data from the AP 210 to one or more of the STAs 221-226. The DL data transmissions 345a-345d may include the transmissions of any types of data and the allocation and duration of the DL data transmissions may be determined by the AP 210. In some implementations, the DL data transmissions 345a-345d may or may not include MU-MIMO transmissions. Such transmissions may be comparable or similar to such communications in traditional Wi-Fi systems.

In some implementations, the scheduling of the DL data transmissions 345a-345d may be based on the buffer fill and recently transmitted traffic. For instance, a proportional fair scheduling mechanism that balances the pending traffic and the traffic that has been sent recently to a STA to achieve a fair allocation of resources to the various links may be used. In some examples the STAs that are scheduled to receive traffic during the downlink frame 310 may not be fully known at the start of the downlink frame 310, since the traffic situation (e.g., incoming data, among other changes to the traffic situation) may change over the course of the downlink frame 310. While this may be more natural for a traditional Wi-Fi based system, such a circumstance may mean that knowledge of the STAs for which ACKs are to be requested is also not available at the start of the downlink frame 310. However, the identification of STAs which are to be granted access to the medium to send ACKs to the DL data transmissions 345a-345d are to be included in the uplink map 340a.

To address this variation, some example implementations include either sending the uplink map 340a later in the downlink frame 310 (e.g., later than the case illustrated in Error! Reference source not found.), or any ACKs may be requested in the uplink map of the subsequent downlink slot.

To determine its channel access opportunities, a given STA (e.g., STA 221) may parse the uplink map 340a. From the uplink map 340a, the STA 221 may extract various pieces of data that are associated with the STA 221 (such as those correspond to the unique STA ID of the STA 221).

In some implementations, a start and end time extracted data may be used to find the time intervals the STA 221 is allowed to access the medium (such as the start time and end time for the second STA-specific portion 380 designed for STA 221). Each STA may receive a single interval allocated during an uplink frame 320. For example, the first station 221 may be assigned the second STA-specific portion 380, the second STA 222 may be assigned the first slot 362 in the administrative portion 360, the third STA 223 may be assigned the second slot 364 in the administrative portion 360, the fourth STA 224 may be assigned the third slot 366 in the administrative portion 360, and the fifth STA 225 may be assigned the first STA-specific portion 370.

The uplink frame 320 may include multiple portions, including an administrative portion 360, a first STA-specific portion 370, a second STA-specific portion 380, and a contention period 390. The administrative portion 360 may include allocations for one or more STAs to submit ACKs, resource allocation requests, and/or other network management communications. In these and other implementations, such administrative allocations may be used exclusively for management frames, such as ACKs and resource allocation requests. The slots 362, 364, and 366 in the administrative portion 360 may be shorter than allocations for data communication (such as the STA-specific portions 370 and 380), as the administrative allocations may be intended for management frames. The uplink traffic is essentially under control of the AP 210. For example, the AP is to decide which STAs to grant airtime and how much airtime will be given to each STA. Within the allocated airtime (and possible access categories), the STA has freedom to perform its own prioritization and scheduling.

In example implementations, only management frames such as ACKs may be sent during the administrative allocations of the slots 362, 364, and/or 366. However, data slots (such as the STA-specific portions 370 and/or 380) may be used in a more flexible manner. Specifically, ACKs and/or resource allocation requests may be sent in data slot as well as regular data. Each STA may implement a similar priority mechanism as described for Downlink Channel Access.

In some implementations, the STA 221 may have management communications available, such as channel sounding feedback, at the start of its designated allocation. If such management communications are present, such frames may be sent on the medium with higher priority over regular data transmission. Similarly, any ACKs not transmitted in the ACK slot may be sent first. For example, an ACK buffer and/or a management buffer may be used to store ACK and/or management frames to be transmitted at a highest priority as soon as the STA has access to the wireless medium. Continuing the example, one or more data buffers for regular data may be used to store the regular data until the higher priority management communications have been transmitted. In some implementations, the regular data may be sorted into different buffers based on priority or class, such as different access categories (AC) of data.

In some implementations, a combination of management frames may be transmitted as a single combined packet with a single overhead and multiple portions of administrative or management data within the packet, such as ACKs and resource allocation requests.

In the uplink direction (e.g., the STA 221 sending an ACK to the AP 210 regarding the data received during the downlink slot 345a), a regular Block ACK may be used. The bitmap of a Block ACK packet may be limited to 128 bits. Since the traffic may include more bursts in an FWA-implemented system, it is possible that the STA 221 may receive more than 128 subframes before it has a chance to send an acknowledgment. In such a circumstance, either the bitmap may be increased or the Block ACK may be broken into multiple transmissions. Since this is a delayed acknowledgment, example implementations include an extended bitmap.

The first STA-specific portion 370 may be an allocation of the wireless medium during the uplink frame 320 during which the designated STA (e.g., the STA 225) may transmit to the AP 210. During the STA-specific portion 370, the STA 225 may transmit any combination of ACKs responding to data received during the previous downlink frame 310a (or a previous downlink frame if the STA 225 had not been allocated any medium prior to the STA-specific portion 370), regular data, and/or resource allocation requests. For example, the first STA-specific portion 370 may include an ACK slot 372, a data slot 374, and a resource allocation request slot 376. Similarly, the second STA-specific portion 380 may include an ACK slot 382, a data slot 384, and a resource allocation request slot 386. Some implementations include aggregation of these various sources of data into a single payload (as opposed to sending them as separate frames), such that MAC overhead can be reduced. Example implementations include various implementations for combined ACK, data frames, and/or resource allocation requests. In these and other implementations, the entire first STA-specific portion 370 may be treated as a single slot for the aggregated payload, and the second STA-specific portion 380 may be treated in a similar manner.

ACKs may be sent during ACK slots (such as the slots 362, 364, and/or 366), but may also be transmitted during data slots (such as the data slot 374 and/or 384).

In some implementations, the uplink frame 320 may include a contention period 390. The purpose of the contention period 390 is to allow STAs that have not been allocated a data transmission slot in the administrative portion 360 or in the STA-specific portions 370, 380 to communicate short control or management packets for urgent communications. Examples of such communications may include indicating resource allocation requests, association requests, or other similar communications.

The protocol for the contention period 390 under FWA may accommodate the fact that distinct STAs are likely hidden from each other and can therefore not rely on carrier sensing to avoid collisions. The occurrence of collisions can reduce the efficiency of the slot substantially. In some implementations, its use may be reserved for high-priority urgent communications and/or packets may be kept as short as possible, below a threshold length, or other constraints to reduce collisions.

Several possible implementations are included for managing the contention period 390, or the resource allocation requests in general, such as randomized transmission start times within the contention period 390, request to send (RTS)/clear to send (CTS) with random start times within the contention period 390, utilizing feedback null data packets (NDP), and/or complete removal of the contention period 390. Such example implementations address if many STAs want to use the contention period 390 to send resource allocation requests. To reduce or avoid the need for transmissions in the contention period 390, STAs may be configured to send their resource allocation requests during any time period that it has been granted access to the medium. This includes, for example, the administrative slots 362, 364, 366 and/or the STA-specific portions 370 and 380, provided that doing so does not interfere with the request from the AP 210 (e.g. if the AP 210 allocates an administrative slot 362 to the STA 222, any available ACKs of the STA 222 may be sent first before using the administrative slot 362 for other purposes).

When using a randomized start time within the contention period, each STA may select a random start time anywhere within the contention period 390 (as signaled in the uplink map 340a— see e.g., FIG. 4). The start time may be chosen such that the transmitted frame is completed before the end time of the contention period 390.

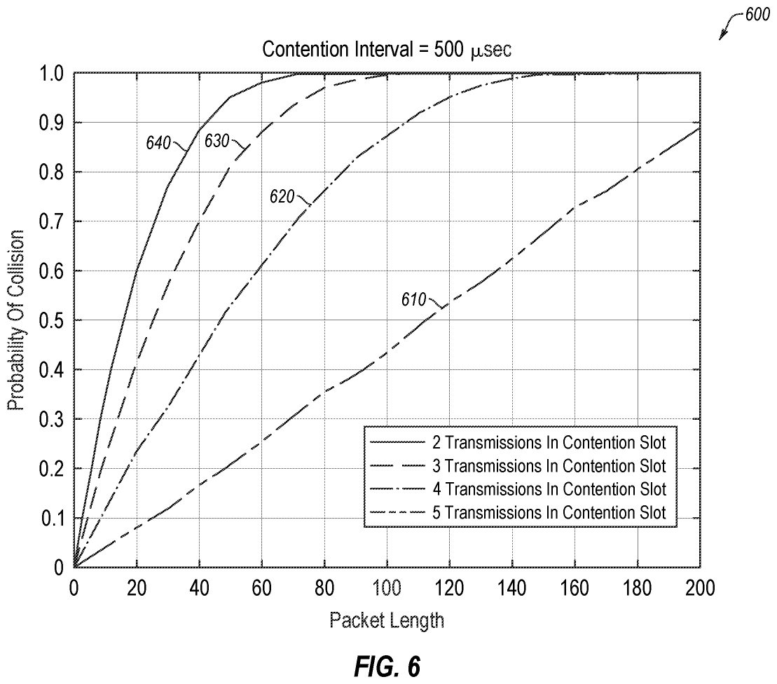

The probability of collision depends on the number of STAs that attempt to access the medium during the contention period 390, the duration of the contention period 390, and the duration of each transmitted packet. In general, the probability of collisions is quite high, even with the very short frames. The probability of collisions is shown and discussed with reference to FIG. 6.

Alternatively to completely randomized start times, a given STA may pick two random numbers: a random start time within the contention period 390, and a countdown parameter N_{CD} that may determine which slot within the contention period 390 the random start time refers to. A value N_{CD}=0 refers to the current timeslot. If N_{CD}>0, the STA may decrement the value with every uplink slot within the contention period 390 until N_{CD}=0. The STA may refrain from transmitting anything in the contention period 390 until N_{CD}=0. The range of N_{CD} may be modified by the AP 210 to adjust to different levels of contention.

Information about N or N_{CD} may be contained in the uplink map 340a. For example, the CP info field (see Error! Reference source not found.) may be extended to include an additional parameter “CP Period.” The “CP Period” data field may convey information about N or N_{CD}. In these and other implementations, the AP 210 may select the value of CP Period. The AP 210 may have some indication of the number of collisions in the contention period 390. For instance, if the AP 210 detects one or more packet preambles during the contention period 390, but the content is systematically corrupted, it may decide to increase the CP Period to see if the situation improves.

Another way to randomize the access to the contention period 390 is by using some version of RTS/CTS. Any STA that attempts to access the contention period 390 may send an RTS first. The AP 210 may respond with CTS if the RTS is received successfully. This is not too different from the randomized transmission times described above, except that it provides an explicit immediate indication that the RTS was received correctly. This will allow the STA to attempt access again if an initial attempt was unsuccessful. However, such a configuration may utilize the permission of transmissions from the AP to the STAs during the uplink frame 320, and specifically within the contention period 390 of the uplink frame 320.

In cases of high load, the RTS transmissions may be spread out using a mechanism similar to the one described using the CP Period information field.

In some implementations, to cut down on transmission times, a modified RTS that already contains the buffer information that the STA is trying to communicate to the AP may be utilized. Otherwise, any successful RTS/CTS would still be followed by the actual resource allocation request, which may increase the successful completion time for each resource allocation request and/or increase the likelihood of collision with additional transmissions during the contention period 390.

Another approach for handling the contention period 390 includes use of a special UL trigger-based frame to gather buffer status indication from many different STAs, such as the high efficiency (HE) trigger-based (TB) feedback null data packet (NDP). For example, in 802.11ax, HE TB feedback NDP is sent in response to an NDP feedback report poll (NFRP) trigger frame from the AP 210. For use in FWA, the timing of the HE TB feedback NDP would be relative to some agreed-upon time reference, such as a certain time during the contention period 390 and/or in response to an NFRP sent during the downlink frame 310a.

Using the HE TB feedback NDP, STAs may respond with a binary indication about their buffer status. In such an implementation, each STA may be allocated a tone set (e.g., 12 tones) to perform signaling. As up to 19 tone-sets are defined in each 20 MHz, multiple STAs may respond within any given contention period 390. Such an approach may or may not provide bandwidth for a full resource allocation request such as shown in FIG. 5 and/or details regarding the data in the buffers of the STAs. However, the AP 210 may utilize the status of the buffers to assign STAs with data in their buffers an allocation in the next uplink frame (or a subsequent uplink frame).

Provided the AP 210 is able to schedule each STA with some regularity, the STAs may be able to indicate their resource needs during scheduled intervals. Resource allocation requests may be allowed in other scheduled slots (such as the administrative slots 362, 362, 366 and/or the STA-specific portions 370 and 380). Such an approach may remove the contention period 390.

If the contention period 390 is experiencing an excessive number of collisions or the AP 210 is repeatedly receiving corrupted data due to a large number of STAs, the AP 210 may instead choose to assign specific slots to replace the contention period 390 to allow the STAs to send the resource allocation requests. In these and other implementations, it may be multiple super frames 305 before each STA is allocated a slot within the contention period 390 (and/or the other portions of the super frame 305).

While the diagram shown in Error! Reference source not found. shows a strict timing of slots in the downlink frame 310a and the uplink frame 320, example implementations may not rely on strict timing knowledge of transmission and reception times for the reception of packets. For example, the use of TSF as a clock-sharing mechanism between the AP 210 and STAs 221-225 may also prevent strict (e.g. accuracy at the microsecond (μsec) level) timing of events.

In another implementation, packet detection may be based on the detection of an 802.11 preamble. The receiving STA 221 may use knowledge of the overall structure of the downlink frame 310a and the uplink frame 320 of the super frame 305 to disable the receiving antenna or other receiving device during times when no packets are expected. Additionally, the receiving STA 221 may not rely on the exact expected starting time of a packet as communicated in the uplink map 340a. For example, the antenna of the receiving STA 221 may turn on +/−5 μsec prior to a designated allocation for the receiving STA 221.

Likewise, for transmissions from the STA 221 to the AP 210, the uplink map 340a may not dictate the exact starting times, or the number of packets expected from the STA 221. Instead, each STA 221-225 may be given a certain time interval in which it has access to the medium. The STA 221 may use its assigned interval in any way it chooses. In such an implementation, transmissions may not be required or expected to fill the complete interval and the number of packets and their transmission times within the interval are at the discretion of the STA 221.

The AP 210 may assign slots in such a way that the slots accurately meet the requirements of the STAs 221-225. For example, the frequency and/or duration of the slots assigned to the STAs 221-225 may be based on previously sent resource allocation requests. In these and other implementations, over-allocation may mean that some of the airtime remains unused, leading to inefficiencies.

Example implementations include the AP 210 actively monitoring how efficiently the STAs 221-225 use the allocated time slots. In response to inefficient usage, the duration and/or frequency of a given STA's allocations may be reduced.

In this less-rigid implementation, the transmitting and receiving devices may largely continue to operate as before in other Wi-Fi systems. Some differences may include: (1) no need to perform clear channel assessment (CCA) when transmitting, as the STA may recognize that it is within the slot allocated to the STA, (2) transmissions may be limited to pre-defined time intervals; (3) reception may be optionally limited to predetermined time intervals. To conserve resources, the receiver of the AP 210 may be switched off during the downlink frames 310a/310b and the receivers of the STAs 221-225 may be switched off during the uplink frame 320. Additionally, the transmitter of a given STA may be switched off during any part of the uplink frame 320 where it does not have permission to transmit.

In some examples this facilitates the reception of data frames, but the FWA technology may include certain management frames (e.g., the uplink map 340a, the beacon 330, and/or various ACKs, among others) to be sent at relatively well-defined intervals. Even for these management frames however, it may be beneficial not to rely on strictly timed access. For example, even though the management frames in FIG. 3 are shown towards the start of the downlink frame 310a, FWA would function properly if the management frames were sent at different times and even in different order, as long as the management frames are received in a timely manner by the STAs 221-225. As such, imposing a too rigid timing may be unnecessary.

To achieve the regular transmission of management frames, example implementations include to allocate them to a high priority transmit buffer. The transmitting device is expected to transmit frames from the high priority buffer when it is not empty. An independent process may write to the buffer at regular intervals (e.g. one beacon every 100 msec). The presence of frames in the buffer may trigger the transmitting device to send the high priority frame(s) in the buffer at the earliest opportunity.

While the term “priority” is used, it does not refer to Access Category or User Priority. Rather, it conveys that the content of the high priority buffer buffers should be treated preferentially over “regular” data. Stated another way, if packets are available in the high priority buffer, they should be sent first before other types of traffic.

ACKS may share the buffer with management frames or be stored in a separate buffer with identical or lower priority (but higher priority than data). Here also, an independently running process may write the pending ACKs to the buffer at regular interval. This may result in the behavior illustrated in Error! Reference source not found.

The periodicity with which the management and ACK processes write to their respective buffers may be configurable. In some implementations, this may be tied to the periodicity of the uplink/downlink frame sequence (e.g. send packets to the buffer every 20 msec for a super frame that is 20 msec in length). Alternatively, the periodicity may be decoupled from the periodicity of the uplink frame/downlink frame sequence (e.g. maintain a 20 msec periodicity, even if the super frame is 625 μsec).

For convenience, the periodicity of the uplink map 340a and ACK frames generation (e.g. how often these frames are written to the respective buffers) may use the same periodicity for reference time as is used within the uplink map 340a. In some implementations, the STA may be configured to send all its available traffic (assuming network resources are not exhausted). During spikes in traffic, the STA may temporarily be unable to fully empty all buffers. This is the case where priority should be given to the ACKs and/or management frames.

In addition to sending data, other packet exchanges can also be supported within the FWA protocol framework described herein.

For example, for sounding and sounding feedback, traditional Wi-Fi sounding and sounding feedback includes a series of announcements, NDP, and beamforming feedback and reporting polls. In FWA, such an alternating sequence of uplink and downlink transmissions cannot be supported since uplink and downlink transmissions take place in separate timeslots.

To be compatible with FWA, the AP 210 may send a null data packet announcement (NDPA) and null data packet (NDP) at any point during the downlink frame 310. The NDPA may identify the STAs that are expected to prepare sounding feedback (e.g., the STAs 221 and 222). The AP 210 may assign data time slots for the STAs 221 and 222. The STAs identified in the NDPA (e.g., the STAs 221 and 222) may prepare sounding feedback frames and store them in their respective management buffers. The sounding feedback may be sent out during a timeslot assigned to the STAs 221 and 222. In these and other implementations, if used in conjunction with the management buffer, the sounding feedback may be sent to the AP 210 before any regular data of the STAs 221 and/or 222.

In these and other example implementations, there may be no need to indicate specific times in the uplink map 340a for the transmission of sounding feedback (or any other management frames in general). Rather, the STAs may be configured to transmit the management data when there is management data to send and when the STA has access to the medium.

Other request and response sequences (e.g. Radio Resource Management) may be implemented in a similar way. The request may be sent by the AP 210 at any time during the downlink frame 310. The response may be sent by the STA in a time slot that is allocated to the STA for uplink data transmission.

Modifications, additions, or omissions may be made to the system 200 and/or the diagram 300 without departing from the scope of the present disclosure. For example, the designations of different elements in the manner described is meant to help explain concepts described herein and is not limiting. Further, the system 200 and/or the diagram 300 may include any number of other elements or may be implemented within other systems or contexts than those described. For example, any number of APs 210 and/or STAs 221-225 may be included. Additionally, the order, duration, gap between communications, etc. of the communications in the diagram 300 are merely illustrative.

FIG. 4 illustrates an example uplink (UL) map 400, described according to at least one implementation of the present disclosure. For example, the payload of the UL map 400 may include an ID 405, version 410, length 415, CP info 420 (that may include a start time 425 and an end time 430), a number of data slots 435, data info 440 for a given slot (which may include a STA ID 445, a countdown 450, a start time 455, an end time 460, AC info 465, and data info for the M^{th} data slot. This payload can be carried in a Wi-Fi management frame.

The various fields in the UL map 400 payload are described in Error! Reference source not found.

TABLE 2
fields in UL map 400

| Field | Interpretation |
|---|---|
| ID 405 | Unique ID that identifies the frame as an UL MAP |
| Version 410 | Version number that identifies the UL MAP definition |
| | By using a version indicator, for various definitions of the UL MAP |
| | with additional content may be permitted. |
| Length 415 | Total number of bytes in the UL MAP payload |
| | In some implementations, if the Length is larger than the number of |
| | bytes expected based on the signaled number of ACK and Data Info |
| | fields, additional information may have been appended to the frame |
| | shown in Error! Reference source not found. 4. The additional |
| | information may be ignored and not considered an error. Such a |
| | response to additional data may permit the future extension of the UL |
| | MAP with various versions, while maintaining compatibility with |
| | older versions of STAs. |
| CP Info 420 | Information on the start and end times of the contention period. The |
| | structure of this field may include two subfields indicating a start and |
| | stop time of the contention period. |
| # Data 435 | Indicates the number of Data Info fields that are included in the UL |
| | MAP 400 (if any). For example, with reference to FIG. 3, this value |
| | would be 2 (referring to the STA-specific portions 370 and 370). |
| Data Info (#1-#M) | One field for each of the data transmissions that are allocated in the |
| 440, 470 | uplink frame. The structure of the Data info field are described in |
| | Table 3. These fields follow the # Data field. |
| | Example implementations may include no more than one entry for |
| | any STA. For example, the time slot for allowable transmissions for a |
| | given STA may be a single contiguous period of time, even if the |
| | STA is ready to transmit an ACK, a resource allocation request, and |
| | various amounts of regular data. |
| # ACK Info 475 | Indicates the number of ACK Info fields that are included in the UL |
| | MAP 400 (if any). For example, with reference to FIG. 3, this value |
| | would be 3 (referring to the administrative slots 362, 364, and 366). |
| ACK Info (#1-#N) | One field for each of the administrative slots that are allocated in the |
| 480, 485 | uplink frame. The structure of the ACK info field include a start time, |
| | an end time, and may optionally include an indication that the slot is |
| | for management frames. |
| | Example implementations may include no more than one entry for |
| | any STA even between the ACK Info and Data Info fields. For |
| | example, the time slot for allowable transmissions for a given STA |
| | may be a single contiguous period of time, even if the STA is ready |
| | to transmit an ACK, a resource allocation request, and various |
| | amounts of regular data. |

The Data Info field includes three subfields, as shown in Error! Reference source not found. The meaning of the various subfields within the Data Info field is given in Error! Reference source not found.

TABLE 3
Subfields in the Data Info field

| Subfield | Interpretation |
|---|---|
| STA ID | Unique identifier of the STA. This may include the Association ID (AID) or |
| | any other unique identifier. |
| Countdown | The Countdown field may optionally indicate that the times refer to a future |
| | UL_MAP_PERIOD, rather than the one associated with the current UL |
| | MAP. The AP may be responsible for decrementing the Countdown subfield |
| | appropriately such that the information communicated to the STAs remains |
| | consistent from one UL MAP to the next. By providing the countdown, a |
| | STA may be aware that it is been assigned an allocation in a future uplink |
| | frame and may refrain from sending additional resource allocation requests |
| | until after the allocated slot has passed. |
| Start Time | Start of the interval in which the identified STA may send data frames. Any |
| | data (or management) transmissions may begin after this time. In some |
| | implementations, the STA may be prevented from beginning transmissions |
| | until after this time. Example implementations may include start and end |
| | times being given in μsec relative to the start of a given reference (such as |
| | the start of the uplink frame within the super frame). |
| End Time | End of the interval in which the identified STA may send data frames. Any |
| | data (or management) transmissions may be completed before this time. In |
| | some implementations, the STA may be required to finish all transmissions |
| | prior to this time. |
| AC Info | Provides information about the Access Categories (ACs) that are allowed |
| | within the assigned time interval. The AC Info may be implemented as a 4- |
| | bit bitmap, with one bit corresponding to each of the ACs. Multiple ACs |
| | may be allowed within the same time period. If more than one AC is |
| | allowed, the STA may have the discretion to choose which one(s) to send. |

The various fields in the UL MAP payload may include time stamps to identify specific transmission intervals. These time stamps may be determined relative to a given reference time. This reference time is reset to zero after each UL_MAP_PERIOD. Additionally or alternatively, the reference times may be based on the TSF of the AP as synchronized with the STAs.

In some implementations, over-the-air latency may be addressed by the AP and/or the STA. Transmissions may be implemented such that the indicated time intervals are respected at the AP receiver. One approach may include introducing additional delay between the actual transmission at the STA and the time the transmission is received at the AP. If the delays are different for different STAs (e.g., due to different distances from the AP), collisions may occur. As such, some knowledge may be beneficial about the over-the-air delays experienced by different STAs. Correction may be applied either by the AP or the STAs.

When applied at the AP, the AP may adjust the time stamps in the ACK Info or Data Info fields. For instance, a remote STA may be instructed to transmit earlier to achieve the same reception window at the AP.

When correction is done by the STA, the STA may understand that any communicated time stamps in the ACK Info or Data Info fields may be expected to be advanced by an amount that depends on the known over-the-air delay between that STA and the AP. A STA may perform “ranging” during association which may facilitate determination of the latency. Example implementations utilize OFDM Rx PHY Latency Register that make the adjustment in the HW that will eliminate the need of SW handling. Example implementations may also include any other ranging algorithms and/or compensation mechanisms.

Additional field types may be added to the UL map 400. These new field types may be added at the end of the structure shown in Error! Reference source not found. This approach may permit older versions of STAs to parse the known content while ignoring any additional information in the UL map 400 that is unknown to the STA. To allow for quick identification of various versions of the UL MAP, a Version field 410 may be provided.

Example implementations may utilize additional signaling in the UL map 400 for multi-user (MU) transmissions in uplink. For example, 802.11ax provides several MU formats for uplink transmission such as UL OFDMA and UL MU-MIMO. These formats involve synchronized transmissions from multiple transmitters. In 802.11ax, synchronization is achieved by having all transmitters start their transmissions relative to a Trigger frame sent by the AP. Using FWA, no (downlink) Trigger frame is expected to be sent during the uplink frame of the super frame. As such, the 802.11ax UL MU trigger synchronization mechanism may be replaced by a new mechanism that is compatible with the time-slotted approach of FWA described in the present disclosure.

In example implementations with the timing reference used by AP and STAs sufficiently well synchronized, UL MU transmission times may be indicated as a start time relative to e.g., the UL_MAP_PERIOD, similarly to the start and end times that are indicated in the ACK Info and/or Data Info fields. In that example, the start time may be interpreted as the actual start of the packet, rather than the start of a transmit opportunity, since multiple frames in an MU transmission start at the exact same time. In 802.11ax, this is achieved by all STAs synchronizing relative to a Trigger frame that is sent by the AP. In FWA, no Trigger frame may be sent in the uplink frame of the super frame. As such, the time reference is to be established in a different way, such as a reference to the UL_MAP_PERIOD. In these and other implementations, all participating STAs may tightly synchronize their time such that the start time is within 0.4 μsec of the designated reference time.

In some implementations, UL MU (either OFDMA or MU-MIMO) may be accomplished through the definition of an additional type of Data Info field in the uplink map 340a. Such an info field may identify the STA IDs of all STAs in the UL MU transmission, the timing of the transmission (e.g., the start time as the exact time at which preamble transmission should start), and the relevant transmission parameters (e.g., modulation coding scheme (MCS), frequency allocation, among others).

Modifications, additions, or omissions may be made to the uplink map 400 without departing from the scope of the present disclosure. For example, the designations of different elements in the manner described is meant to help explain concepts described herein and is not limiting. Further, the uplink map 400 may include any number of other elements or may be implemented within other systems or contexts than those described. For example, any number of additional data fields may be included. Additionally, the order, size, titles, and/or labels in the uplink map 400 are merely illustrative.

FIG. 5 illustrates an example resource allocation request frame 500, described according to at least one implementation of the present disclosure. The resource allocation request frame 500 may represent an indication from a STA to an AP that the STA has data to be uploaded to the AP and is seeking airtime (e.g., requesting a slot within an upcoming uplink frame to upload its data). The resource allocation request frame 500 may be treated as a management frame. The resource allocation request frame 500 may include an ID 510, a length 520, a STA ID 530, Bytes in AC1 540, Bytes in AC2 550, Bytes in AC3 560, and Bytes in AC4 570.

The meaning of the various fields within the resource allocation request frame 500 is given in Table.

TABLE 4
Content of Resource Allocation Request

| Field | Interpretation |
|---|---|
| ID 510 | Unique ID that identifies the frame as a resource allocation request frame |
| Length 520 | Total number of bytes in the resource allocation request |
| STA ID 530 | Unique identifier of the STA. This may include the Association ID (AID) or |
| | any other unique identifier, and may be similar or comparable to the STA ID |
| | field 445 of FIG. 4. |
| Bytes in AC1 | Number of bytes available in Access Category 1. This value may be |
| 540 | expressed as a requested airtime unit (e.g., 4 μsec). For example, the |
| | requested airtime may correspond to an expected amount of time to be used |
| | to send the bytes in question, using an appropriate modulation coding |
| | scheme (MCS)/number of spatial streams (NSS) combination (e.g. the one |
| | used during the last transmission, or a conservative rate if no prior |
| | MCS/NSS is known). |
| Bytes in AC2 | Number of bytes available in Access Category 2, expressed in a similar or |
| 550 | comparable manner to the value in Bytes in AC1 540. |
| Bytes in AC3 | Number of bytes available in Access Category 3, expressed in a similar or |
| 560 | comparable manner to the value in Bytes in AC1 540. |
| Bytes in AC4 | Number of bytes available in Access Category 4, expressed in a similar or |
| 570 | comparable manner to the value in Bytes in AC1 540. |

The resource allocation request frame 500 may be sent at any time the STA has been granted access to the medium, or during the contention period. For example, with reference to FIG. 3, the resource allocation request frame 500 may be sent during the slots 362, 364, 366, during the resource allocation request slots 376 or 386, and/or during the contention period 390.

In an example implementation, the resource allocation request frame 500 may be kept as short as possible. For example, the format for the Bytes in AC1-AC4 fields 540-570 may have a standardized format in a limited number of bits signifying a specific time or range of time.

In some implementations, the resource allocation request frame 500 may not be explicitly acknowledged (e.g., no ACK message is sent in response to the AP receiving the resource allocation request frame 500 from a STA). The AP may respond to the reception of resource allocation request frame 500 inferentially by including the requesting STA in a subsequent UL MAP frame.

In some implementations, the resource allocation request information may be transmitted between the STA and the AP in other formats. For example, certain fields of other communications or packets may be overwritten or used in a different manner to convey the resource allocation request information.

In some implementations, the A-Control field in the MAC header may be used to convey the resource allocation request information. For example, 802.11ax (corresponding to HE packets) redefines the high throughput (HT) Control field in the MAC header to allow the transmission of a variety of information. The definition of HT Control depends on whether the frame is designed for HT/VHT/HE. The A-Control field exists in the HE frames, and is 30 bits in length and includes one or more Control subfields including a Control ID and Control Information. The Control ID subfield may indicate the type of information carried in the Control Information subfield. The length of the Control Information depends on the Control ID. Several types of Control ID have already been defined. An example includes the “BSR Control,” which can be used by STAs compliant with 802.11ax to report certain buffer status information for UL MU operation. The BSR Control represents a similar concept and implementation existing in traditional Wi-Fi standards. In some implementations, the BSR Control or a variation thereof may be used as the resource allocation request 500.

In some example implementations, the FWA protocol may include a new proprietary Control ID for the A-Control field that may be defined. In some implementations, values 7-14 may be currently reserved and so may or may not be used in the definition and/or messaging. Example implementations include use of the A-Control field for UL allocation requests. In these and other circumstances, the A-Control may be used in circumstances in which the STA sends some frame to the AP as the A-Control will be within the MAC header. If no data is available or ready for transmission, the CPE may send a dummy payload to achieve this.

The amount of information that can be conveyed in the A-Control field may be limited (e.g., to 30 bits). Example implementations may allow the A-Control field to be sufficient (e.g., by limiting the request to certain values of time), or alternative implementations may include a fully defined uplink allocation frame payload (e.g., as shown in FIG. 5) that may be maintained.

FIG. 6 illustrate an example visualization 600 of potential collisions in a contention period of an uplink frame, described according to at least one implementation of the present disclosure. The visualization 600 includes collision probabilities for a contention period of duration 500 μsec with varying packet lengths and with the number of STAs accessing the medium varying between 2 and 5 (with the plot 610 corresponding to 2 STAs, the plot 620 corresponding to 3 STAs, the plot 630 corresponding to 4 STAs, and the plot 640 corresponding to 5 STAs).

Assuming purely random access with a contention period duration of T_{C} and a packet duration of T_{P}, the probability of collision for two transmissions trying to access the medium is given by:

$$1 - {( 1 - \frac{{T}_{P}}{{T}_{C} - {T}_{P}} )}^{2}$$

From the equation, it is observed that larger values of T_{C} and smaller values T_{P} will reduce the collision probability.

For short contention periods, it may be difficult to avoid collisions if multiple STAs intend to use the contention period. Example implementations include extending the range of the randomly chosen start times. For example, instead of each STA choosing its value within the interval [Contention Period Start Time, Contention Period End Time], the value may be chosen in an interval CP Start Time+[0, N×(CP End Time−CP Start Time)] for some value of N. Any values that fall outside the current [CP Start Time, CP End Time] interval may refer to start times in subsequent uplink frames. In these and other implementations, one or more of the STAs may be shifted to another contention period in a later uplink frame such that a smaller number of STAs are operating within any given uplink frame. Doing so may facilitate only a small number of STAs at any given time attempting to indicate their resource requests.

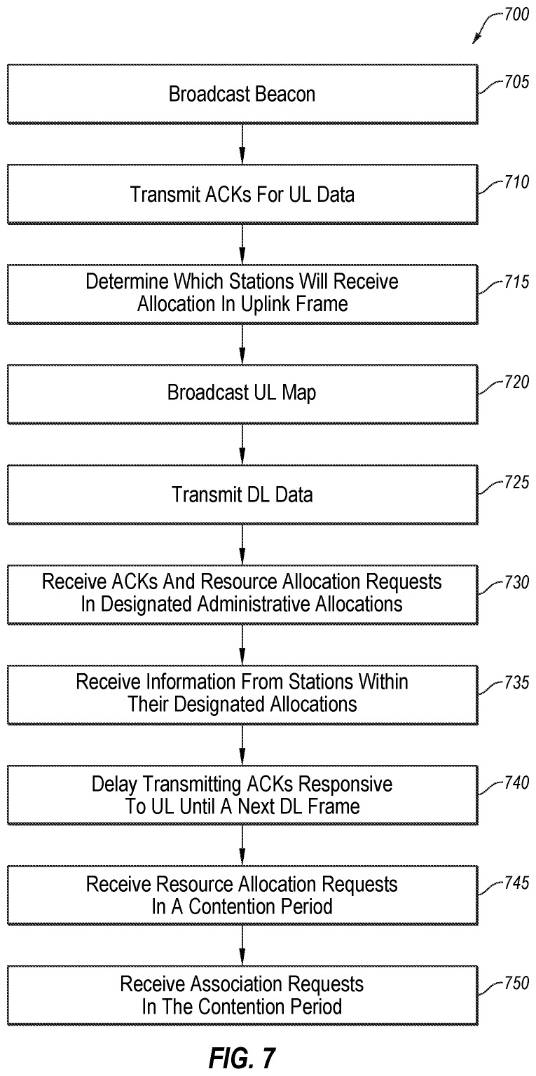

FIG. 7 illustrates a flowchart of an example method 700 of communication using FWA, described according to at least one implementation of the present disclosure.

At block 705, a beacon may be broadcast from an AP to one or more STAs during a downlink frame. The downlink frame may be part of a super frame that includes the downlink frame and an uplink frame. The beacon may include timing information for synchronization of the STAs with the AP. Additionally or alternatively, the beacon may include information regarding the capabilities of the AP, the parameters of the network facilitated by the AP, or other information. In some implementations, the STAs associated with the AP may receive the beacon. Additionally or alternatively, one or more STAs seeking to be associated with the AP and/or in communicative range of the AP may receive the beacon.

At block 710, the AP may transmit ACKs for uplink data. For example, the AP may have received data during a previous uplink frame and may transmit ACKs to the UL data during the downlink frame.

At block 715, the AP may make a determination of which stations will receive allocations in an upcoming uplink frame. For example, the AP may allocate a slot in the next (or a subsequent) uplink frame to some or all of the STAs that sent resource allocation requests to the AP. The AP may designate the duration, the purpose (e.g., administrative, data transmission, or other purposes), or other designations when making the determination. In some implementations, these determinations may be combined into an uplink map.

At block 720, an uplink (UL) map may be broadcast by the AP. For example, the AP may broadcast a UL map that reflects the determination of the STAs with slots within an upcoming uplink frame, as well as the start and end times of those respective slots. The UL map may include any other information as described in the present disclosure. In some implementations, the UL map may be sent early in the downlink frame, such as immediately after the beacon and/or ACKs. Alternatively, the UL map may be sent later in the downlink frame, such as after transmission of one or more DL data transmissions as described at block 725.

At block 725, the AP may transmit downlink (DL) data during the downlink frame. For example, the AP may transmit DL data to one or more STAs.

At block 730, the AP may receive ACKS and/or resource allocation requests during designated administrative allocations of the uplink frame. For example, the STAs that received data during the DL data transmissions of the block 725 (and without an allocated UL data slot in the uplink frame) may be allocated an administrative slot for transmitting ACKs to the AP confirming receipt of the data. Additionally or alternatively, such STAs may transmit a resource allocation request indicating that the STA has data to transmit to the AP, and requesting air time to do so.

At block 735, the AP may receive information from STAs within their designated allocations during the uplink frame. For example, a STA may be designated a STA-specific portion of the uplink frame and may transmit any ACKs, resource allocation requests, other management frames (such as sounding feedback, among others), and/or regular data. In some implementations, the various types of data may be combined into a single payload, or different types of packets may be sent. In some implementations, a STA may use a management buffer and a data buffer, and the STA may empty the management buffer before then transmitting data from the regular data buffer.

At block 740, the AP may delay sending ACKs responsive to the uplink data until a next downlink frame. For example, the AP may receive the management data and/or other data at the block 735, but may delay sending any ACKs to the data until the subsequent downlink frame in the super frame.

At block 745, a resource allocation request may be received by the AP during a contention period. For example, a given STA without an administrative slot and without an STA-specific portion of the uplink frame may transmit a resource allocation request during the contention period.

At block 750, an association request may be received by the AP during the contention period. For example, a STA that is seeking to be associated with the AP may send an association request during the contention period.

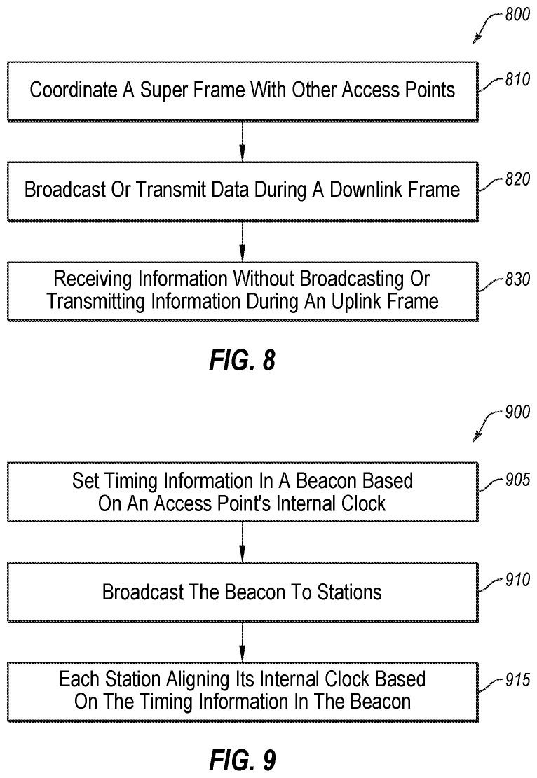

FIG. 8 illustrates a flowchart of an example method 800 of coordinating FWA super frames across multiple access points, described according to at least one implementation of the present disclosure.

At block 810, a super frame may be coordinated with other access points. For example, in some implementations, the various APs may have communication with an external time source to which the various timing mechanisms are aligned. Additionally or alternatively, a third party may designate the timing and ratio of the super frames. This may include designation by a standards setting body or other organization as a standard or schedule with which the AP may comply, such as for 5G communications. In some implementations, the external time source may also include information regarding the super frames (such as a start time, size, and/or ratio of downlink and uplink frames).

At block 820, the AP may broadcast or transmit data during a downlink frame of the super frame. The downlink frame may be timed and sized to be coordinated with other APs as described at block 810.

At block 830, the AP may receive information during an uplink frame without broadcasting or transmitting information during the uplink frame. The uplink frame may be timed and sized to be coordinated with other APs as described at block 810.

FIG. 9 illustrates a flowchart of an example method 900 of coordinating timing information to facilitate communication using FWA, described according to at least one implementation of the present disclosure.

At block 905, timing information in a beacon may be set based on an access point's internal clock. For example, a TSF value may be set in the beacon for transmission.

At block 910, the beacon may be broadcast to STAs. The block 910 may be similar or comparable to the block 705 of FIG. 7.

At block 915, each station may align its internal clock based on the timing information of the beacon. For example, each STA may update its TSF value to match that of the AP as sent in the beacon.

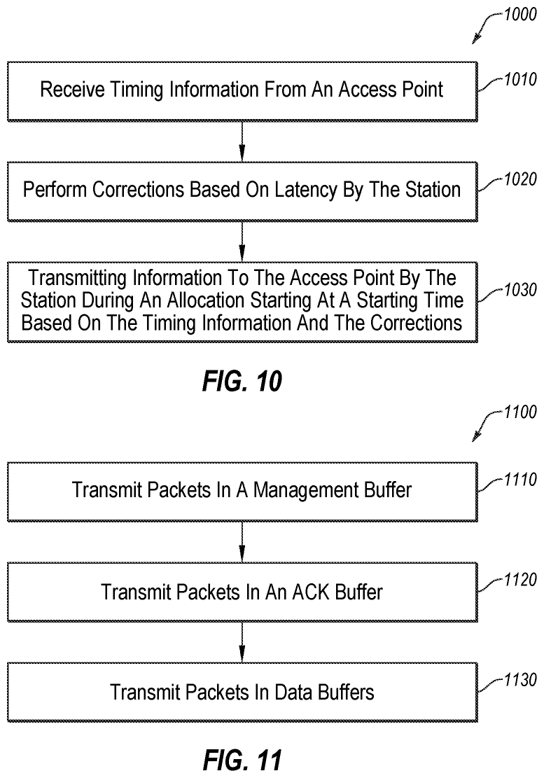

FIG. 10 illustrates a flowchart of an example method 1000 of accounting for latency to facilitate communication using FWA, described according to at least one implementation of the present disclosure.

At block 1010, timing information is received by a station from an access point. For example, a beacon may be received by the STA with a TSF.

At block 1020, corrections may be performed by the station based on latency. For example, the over-the-air latency may be determined by the STA during an association with the AP, and the STA may use that information to determine an acceleration or delay in transmission to be consistent with other transmissions in the network facilitated by the AP.

At block 1030, the station may transmit information to the access point during an allocation starting at a starting time. The transmission may be timed based on the timing and the corrections of the block 1020. For example, an allocation may signal the start of transmission for the STA, and the start time may be determined based on the timing information received at the block 1010. The beginning of the transmission may also be delayed or accelerated based on the corrections of the block 1020.

FIG. 11 illustrates a flowchart of an example method 1100 of prioritizing or scheduling data for communication using FWA, described according to at least one implementation of the present disclosure.

At block 1110, packets may be transmitted from a management buffer. For example, a STA may begin transmissions when their allocated slot arrives during an uplink frame, and may first transmit the packets in a management buffer of the STA.

At block 1120, packets from an ACK buffer may be transmitted. For example, the ACKs for received DL data may be transmitted after the data in the management buffer.

At block 1130, packets from a data buffer may be transmitted. For example, UL data may be transmitted after the data in the management and ACK buffers. In some implementations, the block 1130 may include designations for each level of AC data, such as first transmitting AC1 data, followed by AC2, AC3, and AC4 data, sequentially. In some implementations, the blocks 1110, 1120, and 1130 may represent the order in which data is accumulated into a single payload for transmission. For example, the management data, followed by the ACK data, followed by the UL data may be compiled into a single payload sized to fit within the slot allocated to the STA during the uplink frame.

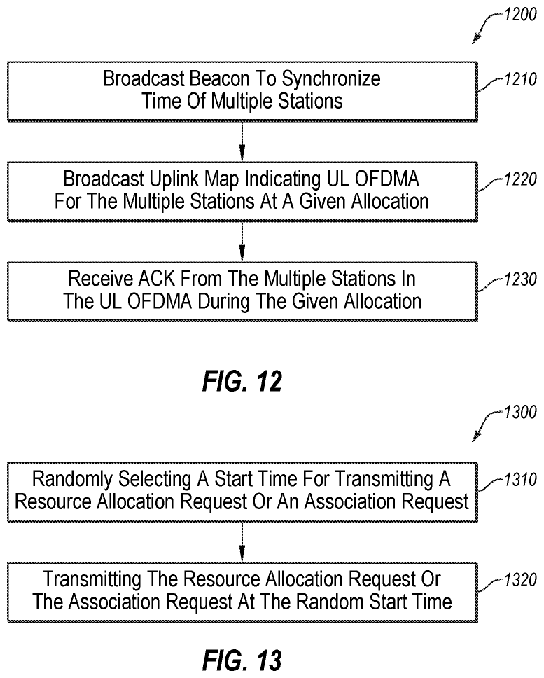

FIG. 12 illustrates a flowchart of an example method 1200 of communicating ACKs to an access point using orthogonal frequency-division multiple access (OFDMA), described according to at least one implementation of the present disclosure.

At block 1210, a beacon may be broadcast to synchronize the time of multiple stations. For example, an AP may broadcast a beacon to multiple stations where the beacon may include the TSF of the AP. In some implementations, other timing information or synchronization technique may be used to synchronize the STAs to the AP to within 0.4 μsec.

At block 1220, an uplink map may be broadcast that includes indication of UL OFDMA for the multiple stations at a given allocation within an uplink frame of a super frame. For example, the uplink map may identify the STA IDs of all STAs in the UL OFDMA transmission, the timing of the transmission (e.g., the start time as the exact time at which preamble transmission should start), and the relevant transmission parameters (e.g., transmit (TX) power, frequency allocation, among others).

At block 1230, at the given allocation, the multiple stations may transmit their ACKs to the AP using the UL OFDMA as indicated in the uplink map. The timing of the UL OFDMA may be based on the synchronization of the multiple stations and the UL OFDMA indication in the uplink map.

FIG. 13 illustrates a flowchart of an example method 1300 of accounting for latency to facilitate communication using FWA, described according to at least one implementation of the present disclosure.

At block 1310, a station may randomly select a start time for transmitting a resource allocation request or an association request. For example, during a contention period, the station may select the random start time to decrease the likelihood of collisions with other transmitting devices.

At block 1320, the station may transmit the resource allocation request or the association request at the random start time.

Modifications, additions, or omissions may be made to any of the methods 700-1300 without departing from the scope of the present disclosure. Additionally, the operations may be performed in any order. Additional blocks may be added, some may be removed, and others may be split into multiple operations. In some implementations, the operations of any of the methods 700-1300 may be performed by one or more computing devices, such as the AP 210 and/or one or more of the STAs 221-225, or combinations thereof.

The teachings herein are applicable to any type of wireless communication system or other digital communication systems. For example, while stations and access points are described for one context of wireless communication, the teachings of the use of pre-equalization are also applicable to other wireless communication such as Bluetooth®, Bluetooth Low Energy, Zigbee®, Thread, mmWave, etc.

One skilled in the art will appreciate that, for these and other processes and methods disclosed herein, the functions performed in the processes and methods may be implemented in differing order, simultaneously, etc. Furthermore, the outlined steps and operations are only provided as examples, and some of the steps and operations may be optional, combined into fewer steps and operations, or expanded into additional steps and operations without detracting from the essence of the disclosed implementations.

The subject technology of the present invention is illustrated, for example, according to various aspects described below. Various examples of aspects of the subject technology are described as numbered examples (1, 2, 3, etc.) for convenience. These are provided as examples and do not limit the subject technology. The aspects of the various implementations described herein may be omitted, substituted for aspects of other implementations, or combined with aspects of other implementations unless context dictates otherwise. For example, one or more aspects of example 1 below may be omitted, substituted for one or more aspects of another example (e.g., example 2) or examples, or combined with aspects of another example. The following is a non-limiting summary of some example implementations presented herein.

In an example a method includes determining, by an access point, which stations among multiple stations are permitted access to a wireless communication medium in a subsequent uplink frame. The method or system may also include broadcasting an uplink map to the stations, where the uplink map identifies a first station of the multiple stations as permitted access to the wireless communication medium. The uplink map may also identify an allocation of the subsequent uplink frame for the first station.

In one or more of the methods of the present disclosure, the method may also include, during the allocation of the subsequent uplink frame allocated to the first station, receiving an acknowledgment of downlink data transmitted to the first station, uplink data, a resource allocation request from the first station requesting access to a second subsequent uplink frame, or combinations thereof. In one or more of the methods of the present disclosure, the method may also include, delaying transmission of an acknowledgment responsive to the received uplink data until after the subsequent uplink frame. In one or more of the methods of the present disclosure, the combinations of the acknowledgment, the uplink data, or the resource allocation request are received with a single header and a combined payload. In one or more of the methods of the present disclosure, the uplink map further identifies a contention period during the subsequent uplink frame.

In one or more of the methods of the present disclosure, the method may also include, during the contention period of the subsequent uplink frame, receiving a resource allocation request from a second station requesting access to a second subsequent uplink frame, the second station without an allocation in the uplink map of the subsequent uplink frame. In one or more of the methods of the present disclosure, the method may also include receiving, during the contention period, an association request from a new station requesting to communicate with the access point. In one or more of the methods of the present disclosure, the method may also include designating at least one allocation to each of the plurality of stations within a threshold amount of time. In one or more of the methods of the present disclosure, the threshold amount of time spans multiple uplink frames. In one or more of the methods of the present disclosure, the uplink map is transmitted during a downlink frame, the subsequent uplink frame and the downlink frame together forming a super frame. In one or more of the methods of the present disclosure, the method may also include coordinating the super frame of the access point with at least one other access point.

In one or more of the methods of the present disclosure, the method may also include transmitting downlink data to the first station prior to the subsequent uplink frame, the uplink map broadcasted previous to transmitting the downlink data to the first station. In one or more of the methods of the present disclosure, the method may also include transmitting downlink data to the first station prior to the subsequent uplink frame, the uplink map broadcasted after transmitting the downlink data to the first station. In one or more of the methods of the present disclosure, the uplink map further identifies an administrative allocation for a third station, the third station receiving downlink data from the access point prior to the subsequent uplink frame, the third station without another allocation in the subsequent uplink frame. In one or more of the methods of the present disclosure, the administrative allocation is of a duration to accommodate an acknowledgment packet, a resource allocation request, or both. In one or more of the methods of the present disclosure, the method may also include broadcasting a beacon to the plurality of stations, the beacon including timing information from the access point, the timing information usable by the stations to synchronize with the access point. In one or more of the methods of the present disclosure, the allocation includes a start time and an end time, the start time based on the timing information from the access point.

A method includes receiving, by a station and from an access point, an uplink map identifying an allocation within a subsequent uplink frame within which the station has access to a wireless medium, the uplink map including a start time and an end time for the allocation. The method may also include, based on the start time of the allocation matching a current time, transmitting information to the access point such that the transmission of information is completed before the end time.

In one or more of the methods of the present disclosure, the method may also include determining the current time based on timing information of the access point received in a beacon broadcasted from the access point. In one or more of the methods of the present disclosure, the method may also include receiving a sounding trigger from the access point; and delaying transmission of a sounding response to the sounding trigger until the allocation. In one or more of the methods of the present disclosure, the information transmitted by the station includes acknowledgments to received downlink data, resource allocation requests, management information, uplink data, or combinations thereof.

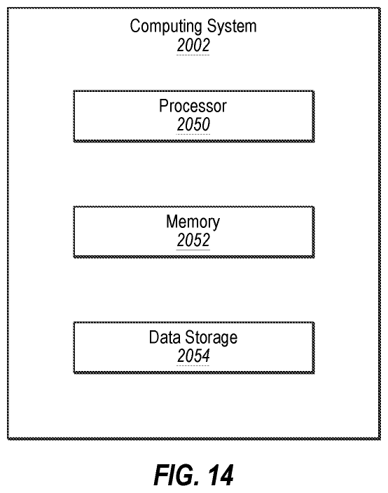

FIG. 14 illustrates a block diagram of an example computing system 2002 that may be used to perform or direct performance of one or more operations described according to at least one implementation of the present disclosure. The computing system 2002 may include a processor 2050, a memory 2052, and a data storage 2054. The processor 2050, the memory 2052, and the data storage 2054 may be communicatively coupled.

In general, the processor 2050 may include any suitable special-purpose or general-purpose computer, computing entity, or processing device including various computer hardware or software modules and may be configured to execute instructions stored on any applicable computer-readable storage media. For example, the processor 2050 may include a microprocessor, a microcontroller, a digital signal processor (DSP), an application-specific integrated circuit (ASIC), a Field-Programmable Gate Array (FPGA), or any other digital or analog circuitry configured to interpret and/or to execute computer-executable instructions and/or to process data. Although illustrated as a single processor, the processor 2050 may include any number of processors configured to, individually or collectively, perform or direct performance of any number of operations described in the present disclosure.

In some implementations, the processor 2050 may be configured to interpret and/or execute computer-executable instructions and/or process data stored in the memory 2052, the data storage 2054, or the memory 2052 and the data storage 2054. In some implementations, the processor 2050 may fetch computer-executable instructions from the data storage 2054 and load the computer-executable instructions in the memory 2052. After the computer-executable instructions are loaded into memory 2052, the processor 2050 may execute the computer-executable instructions.

The memory 2052 and the data storage 2054 may include computer-readable storage media for carrying or having computer-executable instructions or data structures stored thereon. Such computer-readable storage media may include any available media that may be accessed by a general-purpose or special-purpose computer, such as the processor 2050. By way of example, and not limitation, such computer-readable storage media may include tangible or non-transitory computer-readable storage media including Random Access Memory (RAM), Read-Only Memory (ROM), Electrically Erasable Programmable Read-Only Memory (EEPROM), Compact Disc Read-Only Memory (CD-ROM) or other optical disk storage, magnetic disk storage or other magnetic storage devices, flash memory devices (e.g., solid state memory devices), or any other storage medium which may be used to carry or store particular program code in the form of computer-executable instructions or data structures and which may be accessed by a general-purpose or special-purpose computer. Combinations of the above may also be included within the scope of computer-readable storage media. Computer-executable instructions may include, for example, instructions and data configured to cause the processor 2050 to perform a certain operation or group of operations.

Some portions of the detailed description refer to different modules configured to perform operations. One or more of the modules may include code and routines configured to enable a computing system to perform one or more of the operations described therewith. Additionally or alternatively, one or more of the modules may be implemented using hardware including any number of processors, microprocessors (e.g., to perform or control performance of one or more operations), DSP's, FPGAs, ASICs, or any suitable combination of two or more thereof. Alternatively or additionally, one or more of the modules may be implemented using a combination of hardware and software. In the present disclosure, operations described as being performed by a particular module may include operations that the particular module may direct a corresponding system (e.g., a corresponding computing system) to perform. Further, the delineating between the different modules is to facilitate explanation of concepts described in the present disclosure and is not limiting. Further, one or more of the modules may be configured to perform more, fewer, and/or different operations than those described such that the modules may be combined or delineated differently than as described.

Some portions of the detailed description are presented in terms of algorithms and symbolic representations of operations within a computer. These algorithmic descriptions and symbolic representations are the means used by those skilled in the data processing arts to convey the essence of their innovations to others skilled in the art. An algorithm is a series of configured operations leading to a desired end state or result. In example implementations, the operations carried out require physical manipulations of tangible quantities for achieving a tangible result.

Unless specifically stated otherwise, as apparent from the discussion, it is appreciated that throughout the description, discussions utilizing terms such as detecting, determining, analyzing, identifying, scanning or the like, can include the actions and processes of a computer system or other information processing device that manipulates and transforms data represented as physical (electronic) quantities within the computer system's registers and memories into other data similarly represented as physical quantities within the computer system's memories or registers or other information storage, transmission or display devices.

Example implementations may also relate to an apparatus for performing the operations herein. This apparatus may be specially constructed for the required purposes, or it may include one or more general-purpose computers selectively activated or reconfigured by one or more computer programs. Such computer programs may be stored in a computer readable medium, such as a computer-readable storage medium or a computer-readable signal medium. Computer-executable instructions may include, for example, instructions and data which cause a general-purpose computer, special-purpose computer, or special-purpose processing device (e.g., one or more processors) to perform or control performance of a certain function or group of functions.

Although the subject matter has been described in language specific to structural features and/or methodological acts, it is to be understood that the subject matter configured in the appended claims is not necessarily limited to the specific features or acts described above. Rather, the specific features and acts described above are disclosed as example forms of implementing the claims.

An example apparatus can include a Wireless Access Point (WAP) or a station and incorporating a VLSI processor and program code to support. An example transceiver couples via an integral modem to one of a cable, fiber or digital subscriber backbone connection to the Internet to support wireless communications, e.g. IEEE 802.11 compliant communications, on a Wireless Local Area Network (WLAN). The WiFi stage includes a baseband stage, and the analog front end (AFE) and Radio Frequency (RF) stages. In the baseband portion wireless communications transmitted to or received from each user/client/station are processed. The AFE and RF portion handles the upconversion on each of transmit paths of wireless transmissions initiated in the baseband. The RF portion also handles the downconversion of the signals received on the receive paths and passes them for further processing to the baseband.

An example apparatus can be a multiple-input multiple-output (MIMO) apparatus supporting as many as N×N discrete communication streams over N antennas. In an example the MIMO apparatus signal processing units can be implemented as N×N. In various implementations, the value of N can be 4, 6, 8, 12, 16, etc. Extended MIMO operation enables the use of up to 2N antennae in communication with another similarly equipped wireless system. It should be noted that extended MIMO systems can communicate with other wireless systems even if the systems do not have the same number of antennae, but some of the antennae of one of the stations might not be utilized, reducing optimal performance.

Channel State Information (CSI) from any of the devices described herein can be extracted independent of changes related to channel state parameters and used for spatial diagnosis services of the network such as motion detection, proximity detection, and localization which can be utilized in, for example, WLAN diagnosis, home security, health care monitoring, smart home utility control, elder care, automotive tracking and monitoring, home or mobile entertainment, automotive infotainment, and the like.

Unless specific arrangements described herein are mutually exclusive with one another, the various implementations described herein can be combined in whole or in part to enhance system functionality and/or to produce complementary functions. Likewise, aspects of the implementations may be implemented in standalone arrangements. Thus, the above description has been given by way of example only and modification in detail may be made within the scope of the present invention.

With respect to the use of substantially any plural or singular terms herein, those having skill in the art can translate from the plural to the singular or from the singular to the plural as is appropriate to the context or application. The various singular/plural permutations may be expressly set forth herein for sake of clarity. A reference to an element in the singular is not intended to mean “one and only one” unless specifically stated, but rather “one or more.” Moreover, nothing disclosed herein is intended to be dedicated to the public regardless of whether such disclosure is explicitly recited in the above description.

In general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). Furthermore, in those instances where a convention analogous to “at least one of A, B, and C, etc.” is used, in general, such a construction is intended in the sense one having skill in the art would understand the convention (e.g., “a system having at least one of A, B, and C” would include but not be limited to systems that include A alone, B alone, C alone, A and B together, A and C together, B and C together, or A, B, and C together, etc.). Also, a phrase presenting two or more alternative terms, whether in the description, claims, or drawings, should be understood to include one of the terms, either of the terms, or both terms. For example, the phrase “A or B” will be understood to include the possibilities of “A” or “B” or “A and B.”

Additionally, the use of the terms “first,” “second,” “third,” etc., are not necessarily used herein to connote a specific order or number of elements. Generally, the terms “first,” “second,” “third,” etc., are used to distinguish between different elements as generic identifiers. Absence a showing that the terms “first,” “second,” “third,” etc., connote a specific order, these terms should not be understood to connote a specific order. Furthermore, absence a showing that the terms first,” “second,” “third,” etc., connote a specific number of elements, these terms should not be understood to connote a specific number of elements.

The present invention may be embodied in other specific forms without departing from its spirit or essential characteristics. The described implementations are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A method, comprising:
determining, by an access point, which stations among a plurality of stations are permitted access to a wireless communication medium in a subsequent uplink frame; and
broadcasting an uplink map to the plurality of stations, the uplink map identifying a first station of the plurality of stations as permitted access to the wireless communication medium, the uplink map further identifying an allocation of the subsequent uplink frame for the first station.

2. The method of claim 1, further comprising, during the allocation of the subsequent uplink frame allocated to the first station, receiving an acknowledgment of downlink data transmitted to the first station, uplink data, a resource allocation request from the first station requesting access to a second subsequent uplink frame, or combinations thereof.

3. The method of claim 2, further comprising delaying transmission of an acknowledgment responsive to the received uplink data until after the subsequent uplink frame.

4. The method of claim 2, wherein the combinations of the acknowledgment, the uplink data, or the resource allocation request are received with a single header and a combined payload.

5. The method of claim 1, wherein the uplink map further identifies a contention period during the subsequent uplink frame.

6. The method of claim 5, further comprising, during the contention period of the subsequent uplink frame, receiving a resource allocation request from a second station requesting access to a second subsequent uplink frame, the second station without an allocation in the uplink map of the subsequent uplink frame.

7. The method of claim 5, further comprising receiving, during the contention period, an association request from a new station requesting to communicate with the access point.

8. The method of claim 1, further comprising designating at least one allocation to each of the plurality of stations within a threshold amount of time.

9. The method of claim 8, wherein the threshold amount of time spans multiple uplink frames.

10. The method of claim 1, wherein the uplink map is transmitted during a downlink frame, the subsequent uplink frame and the downlink frame together forming a super frame.

11. The method of claim 10, further comprising coordinating the super frame of the access point with at least one other access point.

12. The method of claim 1, further comprising transmitting downlink data to the first station prior to the subsequent uplink frame, the uplink map broadcasted previous to transmitting the downlink data to the first station.

13. The method of claim 1, further comprising transmitting downlink data to the first station prior to the subsequent uplink frame, the uplink map broadcasted after transmitting the downlink data to the first station.

14. The method of claim 1, wherein the uplink map further identifies an administrative allocation for a third station, the third station receiving downlink data from the access point prior to the subsequent uplink frame, the third station without another allocation in the subsequent uplink frame.

15. The method of claim 14, wherein the administrative allocation is of a duration to accommodate an acknowledgment packet, a resource allocation request, or both.

16. The method of claim 1, further comprising broadcasting a beacon to the plurality of stations, the beacon including timing information from the access point, the timing information usable by the stations to synchronize with the access point.

17. The method of claim 16, wherein the allocation includes a start time and an end time, the start time based on the timing information from the access point.

18. A method, comprising:
receiving, by a station and from an access point, an uplink map identifying an allocation within a subsequent uplink frame within which the station has access to a wireless medium, the uplink map including a start time and an end time for the allocation; and
based on the start time of the allocation matching a current time, transmitting information to the access point such that the transmission of information is completed before the end time.

19. The method of claim 18, further comprising determining the current time based on timing information of the access point received in a beacon broadcasted from the access point.

20. The method of claim 18, further comprising:
receiving a sounding trigger from the access point; and
delaying transmission of a sounding response to the sounding trigger until the allocation.

21. The method of claim 18, wherein the information transmitted by the station includes acknowledgments to received downlink data, resource allocation requests, management information, uplink data, or combinations thereof.
